(19) United States
(12) Patent Application Publication
(10) Pub. No.: US 2024/0028888 A1
(43) Pub. Date: Jan. 25, 2024

(54) COMPUTER SYSTEMS FOR COMPRESSING TRANSFORMER MODELS AND QUANTIZATION TRAINING METHODS THEREOF

(71) Applicant: SAMSUNG ELECTRONICS CO., LTD., Suwon-si (KR)

(72) Inventors: Yongsuk Kwon, Suwon-si (KR); Jungwook Choi, Seoul (KR); Minsoo Kim, Seoul (KR); Seongmin Park, Seoul (KR)

(73) Assignees: SAMSUNG ELECTRONICS CO., LTD., Suwon-si (KR); IUCF-HYU (Industry-University Cooperation Foundation Hanyang University), Seoul (KR)

(21) Appl. No.: 18/101,744

(22) Filed: Jan. 26, 2023

(30) Foreign Application Priority Data
Jul. 25, 2022 (KR) 10-2022-0092029

(51) Int. Cl. G06N 3/08; G06N 3/0495

(52) U.S. Cl. CPC G06N 3/08; G06N 3/0495

(57) ABSTRACT

A method for quantization learning by a model quantizer that is operating in a computer system and compressing a transformer model. The method may include generating a student model through quantization of the transformer model, performing a first quantization learning by inserting a self-attention map of a teacher model into a self-attention map of the student model, and performing a second quantization learning using a knowledge distillation method so that the self-attention map of the student model follows the self-attention map of the teacher model.

### CROSS-REFERENCE TO RELATED APPLICATION

This application claims priority under 35 U.S.C. § 119 to Korean Patent Application No. 10-2022-0092029 filed on Jul. 25, 2022, in the Korean Intellectual Property Office, and the entire contents of the above-identified application are incorporated by reference herein.

### BACKGROUND

Some embodiments of the present disclosure relate to computer systems, and more particularly, to computer systems that are configured to compress a transformer model and a quantization learning method thereof.

As Bidirectional Encoder Representations from Transformers (BERT) appeared in the field of artificial intelligence, huge models began to appear in the field of natural language processing. The BERT is a Transformer-based model that enables pre-training and fine-tuning of huge models in natural language processing just like computer vision, and has shown excellent performance in a variety of problems.

However, one disadvantage of the BERT is that the size of the model is very large, and the BERT-base model is known to use about 110 million parameters. Therefore, a very large amount of memory is required to use the BERT, and the size of the system may be inevitably enlarged as a result. In order to operate on a device such as a mobile device or a storage device, model compression of BERT is required.

As a model compression method, quantization or knowledge distillation (hereinafter, KD) is used. Knowledge distillation KD uses a method of training a Student Model by transferring the generalization ability of a Teacher Model, which is the model before the weight reduction. That is, the Student Model may be much smaller in size compared to the Teacher Model. For example, a Teacher Model may be a trained deep neural network model, and the Teacher Model may be compressed using quantization or distillation to generate a Student Model having similar accuracy as the Teacher Model.

In the quantization of the existing transformer model, one problem may be that the accuracy of compression is insufficient. In addition, when the data augmentation technique is not used together for a task with insufficient data, the accuracy after applying quantization may be very poor. In addition, a core operation including the learning of the model parameters related to the self-attention operation of the transformer model may not be properly performed. Based on this background, in order to increase the accuracy of transformer model quantization and to obtain improved compression accuracy even with small data, new compression and learning methods focusing on self-attention map recovery are under investigation.

### SUMMARY

Some embodiments of the present disclosure provide computer systems for compressing or quantizing transformer models with high accuracy, and quantization learning methods thereof.

According to some embodiment of the inventive concepts, a method may be provided for quantization learning by a model quantizer that is operating in a computer system and compressing a transformer model. The method may include, generating a student model through quantization of the transformer model, performing a first quantization learning step by inserting a self-attention map of a teacher model into a self-attention map of the student model, and performing a second quantization learning step in a knowledge distillation method so that the self-attention map of the student model follows the self-attention map of the teacher model.

According to some embodiment of the inventive concepts, a computer system for compressing a transformer mode may include a processor; and memory storing non-transitory computer-readable instructions that include an executable model quantizer software configured to be executed by the processor to compress the transformer model, wherein, when executed the model quantizer software is configured to perform: a first quantization learning step of generating a student model through quantization of the transformer model, and inserting a self-attention map of a teacher model into a self-attention map of the student model to perform quantization learning, and a second quantization learning step of performing quantization learning so that the self-attention map of the student model follows the self-attention map of the teacher model.

According to some embodiments of the inventive concepts, a quantization learning method for compressing a transformer model is provided, and the method may include, generating a student model and a teacher model through quantization of the transformer model, performing a first quantization learning step on the student model by replacing a self-attention map of the student model with a self-attention map of the teacher model, and performing a second quantization learning step on the student model so that the self-attention map of the student model follows the self-attention map of the teacher model.

### BRIEF DESCRIPTION OF THE FIGURES

The above and other objects and features of the present disclosure will become apparent by describing in detail embodiments thereof with reference to the accompanying drawings.

FIG. 1 is a block diagram showing an example of a hardware structure of a model compression system according to one or more embodiments of the present disclosure.

FIG. 2 is a flowchart illustrating a two-step quantization learning operation procedure based on knowledge distillation that may performed in the model compression systems according to one or more embodiments of the present disclosure.

FIG. 3 is a diagram illustrating a first step quantization learning algorithm in the quantization learning procedure according to one or more embodiments of the present disclosure.

FIG. 4 is a diagram illustrating a second step quantization learning in the quantization learning procedure according to one or more embodiments of the present disclosure.

FIG. 5 is a diagram illustrating self-attention maps showing the effects of one or more embodiments of the present disclosure.

FIG. 6 is a cross-sectional view illustrating a memory system capable of processing natural language processing or various applied operations using a compressed transformer model according to one or more embodiments of the present disclosure.

FIG. 7 is a block diagram schematically illustrating the configuration of the logic die of FIG. 6 according to one or more embodiments of the present disclosure.

FIG. 8 is a diagram showing a memory system to which a compress transformer model is applied according to one or more embodiments of the present disclosure.

### DETAILED DESCRIPTION

It is to be understood that both the foregoing summary section and the following detailed description merely provide some examples of embodiments of the inventive concepts provided by the present disclosure, and it is to be considered that additional aspects of the inventive concepts are provided when the present disclosure is considered by those of skill in the art to which the present disclosure pertains. Reference signs are indicated in detail in preferred embodiments of the present disclosure, examples of which are indicated in the reference drawings. Wherever possible, the same reference numbers are used in the description and drawings to refer to the same or like parts.

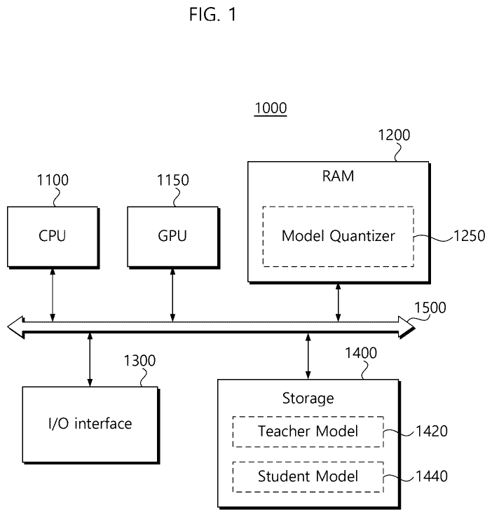

FIG. 1 is a block diagram showing an example of a hardware structure of a model compression system according to one or more embodiments of the present disclosure. Referring to FIG. 1, the model compression system 1000 may include a CPU 1100, a GPU 1150, a RAM 1200, an input/output interface 1300, a storage 1400, and a system bus 1500. Here, the model compression system 1000 may be configured as a dedicated device for executing the transformer model of the present disclosure, but may also be a computer system or a workstation.

The CPU 1100 may be configured to execute software (e.g., application programs, operating systems, device drivers, etc.) that is to be executed in the model compression system 1000. The CPU 1100 may be configured to execute an operating system (OS, not shown) that is loaded into the RAM 1200. The CPU 1100 may be configured to execute various application programs to be driven based on an operating system OS. For example, CPU 1100 may execute a model quantizer 1250 that is loaded into RAM 1200. The model quantizer 1250 of the present disclosure may be driven by the CPU 1100 or the GPU 1150, and may perform compression calculation and learning of a large-capacity transformer model.

The CPU 1100 may process the two-step quantization learning operation by running the model quantizer 1250. That is, by using or running the model quantizer 1250, the transformer model may be configured to perform a first step quantization learning in which quantization learning is performed while the self-attention map of the teacher model is inserted into the self-attention map of the student model. At this time, the self-attention map of the student model, which is the target of quantization learning, is in a state before quantization. Accordingly, learning of the remaining parameters (hereinafter, PROP) rather than the parameters related to the self-attention map (hereinafter, SA-GEN) may occur (e.g., may occur intensively) by or as a result of the quantization learning performed in this state. In the second step quantization learning, the model quantizer 1250 may perform (e.g., may perform intensively) quantization learning on the parameter (SA-GEN) related to the self-attention map of the student model. At this time, quantization learning is performed so that the self-attention map (SAMs) of the student model can follow the self-attention map (SAMt) of the teacher model. Through the two-step quantization learning operation of the transformer model, it may be possible to reduce the weight of the transformer with high accuracy and speed.

The GPU 1150 may be configured to perform various graphic operations and/or parallel processing operations. That is, when compared with the CPU 1100, the GPU 1150 may have an advantageous operation structure for parallel processing in which similar operations are repeatedly processed. Accordingly, the GPU 1150 may be used not only for graphic operations but also for various operations requiring high-speed parallel processing. For example, the GPU 1150 may be configured to perform a graphics processing task and/or a general-purpose task is referred to as General Purpose computing on Graphics Processing Units (GPGPU). Some fields for which GPGPU is suited include video encoding, molecular structure analysis, cryptanalysis, and weather change prediction, with the present disclosure not limited to such fields. The GPU 1150 may efficiently take charge of the iterative operation used for quantization learning provided by the present disclosure.

An operating system (OS) or application programs may be loaded into the RAM 1200. When the model compression system 1000 is booted, an OS image (not shown) that is stored in the storage 1400 may be loaded into the RAM 1200 based on a booting sequence. All input/output operations of the model compression system 1000 may be supported by the operating system (OS). Similarly, application programs may be loaded into the RAM 1200 to be selected by the user and/or to provide basic services. In particular, the model quantizer 1250 of the present disclosure will also be loaded into the RAM 1200 at boot time. The RAM 1200 may be a volatile memory such as a static random access memory (SRAM) or a dynamic random access memory (DRAM), or a nonvolatile memory such as a PRAM, MRAM, ReRAM, FRAM, or NOR flash memory.

The model quantizer 1250 may be driven by the CPU 1100 to perform a two-step quantization learning operation of the transformer model. In the first step quantization learning, the self-attention map for each layer of the teacher model that is already well-trained by the model quantizer 1250 is inserted into the self-attention map portion of the student model. In this case, the self-attention map of the student model may be changed to the state before quantization. In this state, through quantization learning of the student model, it may be possible to learn comparatively intensely the remaining parameters (PROP), rather than the parameters related to the self-attention map (SA-GEN). At this time, the parameter (SA-GEN) related to the self-attention map of the student model does not affect the learning operation of the student model. Therefore, the gradient value flowing from the parameter (SA-GEN) related to the self-attention map to the remaining parameters (PROP) may be cut off or blocked.

In the subsequent second step quantization learning, the model quantizer 1250 simultaneously performs quantization learning on the self-attention map-related parameters (SA-GEN) and the remaining parameters (PROP) intensively learned in the first step quantization learning. At this time, quantization learning is performed so that the self-attention map of the student model can follow the self-attention map of the teacher model. The self-attention map learning in general quantization learning may proceed based on the difference in parameter values between the teacher model and the student model. However, in the learning of the quantization model according to one or more embodiments of the present disclosure, in order to better learn the self-attention map, the Kullback-Leibler Divergence (KLD) method may be used without using or instead of using the mean square error MSE. However, one or more embodiments of the present disclosure is not limited thereto. Using the Kullback-Leibler divergence (KLD) method, the distance between the parameter probability distributions of the teacher model and the student model may be calculated as a loss value. Through this, the self-attention map of the teacher model can be followed more accurately by the self-attention map of the student model, and thus, better knowledge distillation learning may be possible. Through the two-step quantization learning operation of the model quantizer 1250, it may be possible to reduce the weight of the transformer model with high accuracy and speed.

The input/output interface 1300 may be configured to control user input and output from user interface devices. For example, the input/output interface 1300 may include a keyboard or a monitor to receive commands or data from a user. Parameters or data of neural network models that are compressed by the model quantizer 1250 of the present disclosure may be provided through the input/output interface 1300. In addition, the input/output interface 1300 may display the progress of the learning operation or the processing result of the model compression system 1000.

The storage 1400 may be provided as a storage medium of the model compression system 1000. The storage 1400 may store a basic teacher model 1420 and a student model 1440 for quantization learning, application programs, an operating system image, a model quantizer image, and various data. In addition, the storage 1400 may store and update data of the student model 1440 that is learned according to the operation of the model quantizer 1250. The storage 1400 may be provided as a memory card (e.g., MMC, eMMC, SD, MicroSD, etc.) or a hard disk drive (HDD). The storage 1400 may include a NAND-type flash memory having a large storage capacity. Alternatively, the storage 1400 may include a next-generation nonvolatile memory such as PRAM, MRAM, ReRAM, or FRAM.

The system bus 1500 may be a system bus for providing a network inside the model compression system 1000. The CPU 1100, the GPU 1150, the RAM 1200, the input/output interface 1300, and the storage 1400 may be connected through the system bus 1500, and data can be exchanged with each other. However, the configuration of the system bus 1500 is not limited to the above description, and may further include other connections for efficient management of the model compression system 1000.

According to the above description, the model compression system 1000 may perform weight reduction of the transformer model with high accuracy and speed through a two-step quantization learning operation according to the driving of the model quantizer 1250. The compressed transformer model corresponding to the student model that may be obtained learning can be driven in a mobile device, a server, or memory devices to which a processor-in-memory (PIM) is applied.

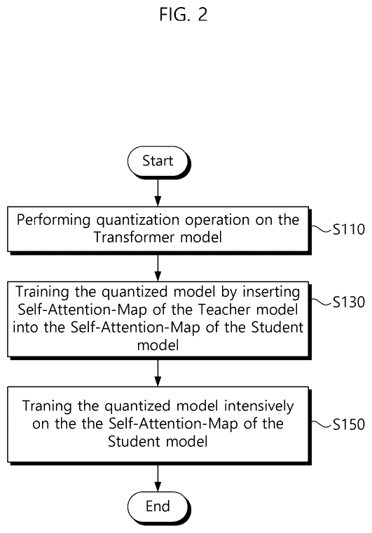

FIG. 2 is a flowchart illustrating a two-step quantization learning operation procedure based on knowledge distillation that may be performed in the model compression system, according to one or more embodiments of the present disclosure. Referring to FIG. 2, the model quantizer 1250 (see FIG. 1) may convert the self-attention map (SAMt) of the teacher model (1420, see FIG. 1) to the self-attention map (SAMs) of the student model (1440, see FIG. 1) to perform the first step quantization learning. When the first step quantization learning is completed, the model quantizer 1250 may perform the second step quantization learning on parameters related to self-attention maps (SAMs).

In step S110, a quantization operation of the transformer model may be performed. That is, the teacher model 1420 and the student model 1440 of the transformer model may be prepared. The teacher model 1420 may be a well-trained transformer model that is trained in advance. The student model 1440 may have the same structure as the teacher model 1420, but may be a quantized transformer model having a reduced layer and/or parameters. That is, the student model 1440 may be generated through quantization of the teacher model 1420.

In step S130, the model quantizer 1250 performs a first step quantization learning using a knowledge distillation technique. In the first step quantization learning, the self-attention maps (SAMs) of the student model 1440 are replaced with the self-attention maps (SAMt) of the teacher model 1420 for each layer. In some embodiments, the self-attention maps (SAMs) of the student model 1440 are changed to the state before quantization, and the loss of the self-attention map between the teacher model 1420 and the student model 1440 hardly occurs. In this case, the self-attention maps (SAMs) of the student model 1440 may be considered to be restored.

Accordingly, when quantization learning of the student model 1440 is performed in this state, learning of parameters SA-GEN related to self-attention maps (SAMs) of the student model 1440 hardly occurs. On the other hand, learning of the remaining parameters (PROP) of the network not related to the self-attention maps (SAMs) of the student model 1440 occurs intensively. At this time, the parameters (SA-GEN) related to self-attention maps (SAMs) of the student model do not affect the learning operation of the student model. Therefore, the gradient value flowing from the parameters (SA-GEN) related to the self-attention maps (SAMs) to the remaining parameters (PROP) is arbitrarily cut off.

In step S150, the model quantizer 1250 performs a second step quantization learning using a knowledge distillation technique. In the second step quantization learning, the model quantizer 1250 performs quantization learning on the self-attention map related parameter (SA-GEN) and the remaining parameters (PROP) intensively trained in the first step quantization learning. At this time, quantization learning is performed so that the self-attention maps (SAMs) of the student model 1440 can follow the self-attention maps (SAMt) of the teacher model 1420. Learning of the self-attention map in general quantization learning proceeds based on the difference in the magnitude of parameter values between the teacher model 1420 and the student model 1440. However, in the learning of the quantization model according to one or more embodiments of the present disclosure, in order to better learn the self-attention map, the Kullback-Leibler Divergence (KLD) method is used without using or instead of using the mean square error MSE. The distance of each parameter probability distribution between the teacher model 1420 and the student model 1440 is calculated as a loss value using the Kullback-Leibler divergence (KLD) method. Based on the calculated loss value, the self-attention map (SAMt) of the teacher model 1420 can be more accurately followed by the self-attention map (SAMs) of the student model 1440, and better knowledge distillation learning may be performed.

In the above, the two-step quantization learning operation procedure by the model quantizer 1250 has been briefly described. Through the two-step quantization learning operation, a student model 1440 can be obtained having high quantization accuracy and/or high-speed quantization learning.

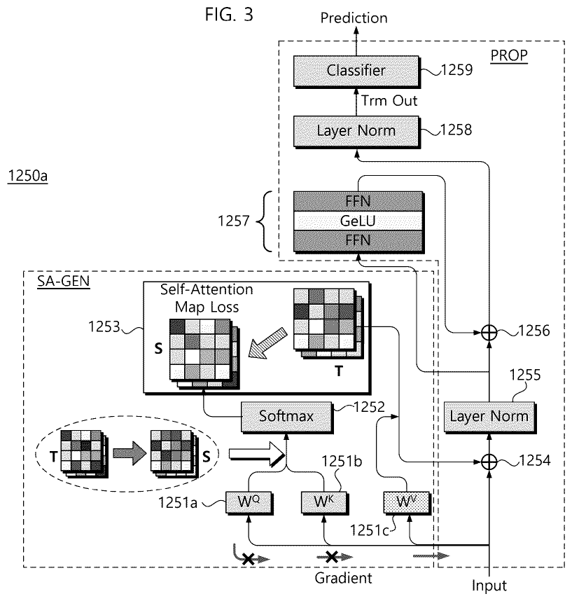

FIG. 3 is a diagram schematically illustrating a first step quantization learning algorithm in the quantization learning procedure of the present disclosure. Referring to FIG. 3, a first step quantization learning algorithm 1250a in which self-attention map recovery performed by the model quantizer 1250 is schematically illustrated. Here, quantization learning will be described for only one layer. However, it will be well understood that the same quantization learning as described may be applied to each of the plurality of layers.

In the first step quantization learning 1250a, substitution of the self-attention map in the first parameter unit SA-GEN and intensive parameter learning in the second parameter unit PROP may occur. First, a softmax function 1252 may be used to convert a product of a query weight (WQ) 1251a and a key weight (WK) 1251b of an input for learning into a probability value. At this time, the attention score loss of the self-attention map (T) of the teacher model and the self-attention map (S) of the student model may be determined.

In the self-attention map replacement step 1253, the layer-by-layer self-attention map T of the teacher model 1420 (e.g., a first self-attention map) may replace respective self-attention map S portions of the student model 1440 (e.g., a second self-attention map) based on the result of the softmax function 1252. In this case, the self-attention map S of the student model 1440 may be changed to a state before quantization, and comparatively little loss of the self-attention map of the teacher model 1420 and the student model 1440 may occur. That is, the self-attention map S of the student model 1440 may be regarded as a fully restored state. In this state, comparatively little learning of the self-attention map may occur, and learning is instead concentrated on the second parameter unit PROP corresponding to the remaining parameters.

The second parameter unit PROP may receive the weights W^{Q} 1251a, W^{K} 1251b, and W^{V} 1251c by a first adder 1254 and a first layer normalizer 1255 for residual connection from the first parameter unit SA-GEN. In step 1257, a feed-forward network (FNN) and a nonlinear function (e.g., GeLU) may be used to adjust the size of the weights. Next, a prediction value may be output through a second adder 1256, a second layer normalizer 1258, and a classifier 1259.

Accordingly, when quantization learning is performed in this state, comparatively little learning of the first parameter unit SA-GEN related to the self-attention map S of the student model 1440 occurs. On the other hand, relatively intense learning of the second parameter unit PROP that is not related to the self-attention map S occurs. At this time, the first parameter unit SA-GEN related to the self-attention map S of the student model does not affect the learning operation of the student model. Accordingly, gradient values of the weights WQ and WK flowing from the first parameter unit SA-GEN related to the self-attention map S to the second parameter unit PROP may be blocked or forcibly cut off. That is, the first parameter unit SA-GEN may not provide gradient values of the weights W^{Q} and W^{K} to the second parameter unit PROP.

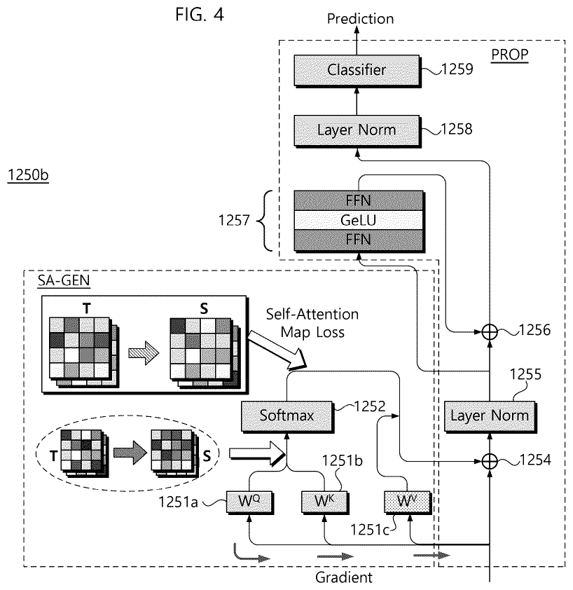

FIG. 4 is a diagram schematically illustrating a second step quantization learning in the quantization learning procedure according to one or more embodiments of the present disclosure. Referring to FIG. 4, the second parameter unit PROP intensively learned in the first step quantization learning by the model quantizer 1250 and the first parameter unit SA-GEN related to the self-attention map are learned together. Then, the self-attention map (S) of the student model can follow the self-attention map (T) of the teacher model. Here, the self-attention map (S) of the student model following the self-attention map (T) of the teacher model may mean that the self-attention map (S) is similar to the self-attention map (T) by a predetermined degree. For example, the self-attention map (S) having a high accuracy may be almost identical to the self-attention map (T).

In the second step quantization learning 1250b, the model quantizer 1250 may perform (e.g., may perform simultaneously) quantization learning on the first parameter unit SA-GEN associated with the self-attention map and the second parameter unit PROP that was learned (e.g., intensively learned) in the first step quantization learning process. At this time, quantization learning may be performed so that the self-attention map S of the student model 1440 can follow the self-attention map T of the teacher model 1420.

Learning of the self-attention map in general quantization learning may proceed based on the difference in the magnitude of parameter values between the teacher model 1420 and the student model 1440. However, in the learning of the quantization model of the present disclosure, in order to better learn the self-attention map, the Kullback-Leibler divergence (KLD) method is used instead of the mean square error MSE. The distance of each parameter probability distribution between the teacher model 1420 and the student model 1440 is calculated as a loss value using the Kullback-Leibler divergence KLD method. In addition, gradient values of the weights W^{Q} and W^{K} flowing from the first parameter unit SA-GEN related to the self-attention map S to the second parameter unit PROP are opened. That is, the first parameter unit SA-GEN may provide gradient values of the weights W^{Q} and W^{K} to the second parameter unit PROP. As such, the self-attention map S of the student model 1440 can more accurately follow the self-attention map T of the teacher model 1420, thereby enabling better knowledge distillation learning.

Through the two-step quantization learning described above, it may be possible to generate a compressed model having a lower loss than conventional methods. Furthermore, it may be possible to create a compressed model with better language task performance. In addition, it may be possible to reduce the amount of data required to train the quantization model by creating a compressed model with better performance than existing methods using the same amount of data. In addition, the self-attention map of the model learned through two-step quantization learning can be closer to the self-attention map before quantization resulting from the conventional methods.

Accordingly, if some of the present inventive concepts are used to reduce the weight of many transformer-based language models using attention operation in quantization-based model learning, it may be possible that a compressed model with comparatively high performance and high accuracy at low cost and efficient learning can be implemented.

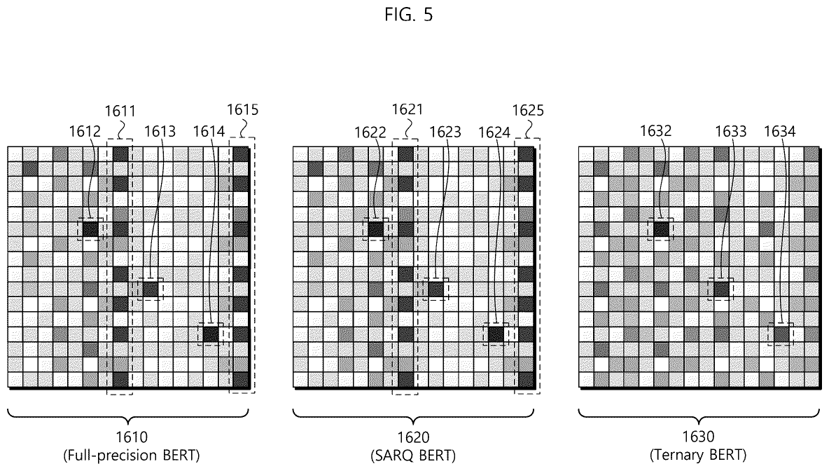

FIG. 5 is a diagram showing self-attention maps and briefly showing the effects of the present disclosure. FIG. 5 shows examples of a self-attention map 1610 before quantization is applied, a self-attention map 1620 of a quantized model of the present disclosure, and a self-attention map 1630 of a general quantized (ternary BERT) model are shown.

The self-attention map 1610 before quantization may be, for example, a self-attention map generated from non-quantized Bidirectional Encoder Representations from Transformers (BERT). A darker portion of the map may be considered to have a higher attention value. Here, for comparison, high attention values 1611, 1612, 1613, 1614, and 1615 are shown individually or in groups.

In the self-attention map 1630 of a general ternary BERT model, only portions 1632, 1633, and 1634 are similar to portions 1612, 1613, and 1614 of the self-attention map 1610 before quantization are applied. That is, only portions 1632, 1633, 1634 having higher attention values are maintained as a result of applying a general ternary BERT model. It can be seen that the quantization learning accuracy of the transformer model to which general quantization (e.g., ternary BERT) is applied is remarkably poor.

On the other hand, it can be seen that the self-attention map 1620 generated from the transformer model (BERT) to which a Self-Attention Recovery Quantization (SARQ) according to one or more embodiments is applied does not substantially differ from the self-attention map 1610 prior to the quantization. Compared with the self-attention map 1630 of a general ternary BERT model, the self-attention map 1620 shows that quantization with high accuracy may be implemented. That is, the positions of the high attention values 1621, 1622, 1623, 1624, and 1625 of the self-attention map 1620 resulting from some embodiments according to the present disclosure may be substantially the same as the self-attention map 1610 of the transformer model before quantization is applied. Stated differently, the self-attention map 1620 generated from the transformer model (BERT) to which the SARQ is applied shows comparatively little difference in accuracy from the self-attention map 1610 before the quantization is applied, especially when compared with the self-attention map 1630 of the general ternary BERT model.

The quantization accuracy of the two-step quantization learning operation of the present disclosure can be identified through the self-attention maps 1610, 1620, and 1630 described above. Through the two-step quantization learning operation according to one or more embodiments of the present disclosure, it is possible to more accurately learn the Self-Attention-Map. Therefore, it is possible to create a quantization model with high performance with less amount of train data and cost.

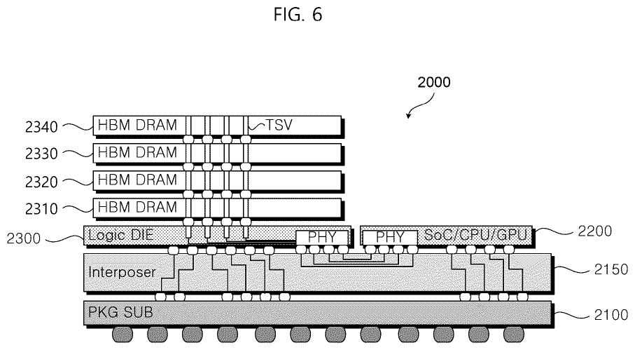

FIG. 6 is a cross-sectional view illustrating a memory system capable of processing natural language processing or various applied operations using a compressed transformer model according to some embodiments of the present disclosure. Referring to FIG. 6, a memory system 2000 may be implemented as a stacked memory that includes a PCB substrate 2100, an interposer 2150, a host die 2200, a logic die 2300, and high bandwidth memories (HBMs) 2310, 2320, 2330 and 2340.

The memory system 2000 may connect the HBMs 2310, 2320, 2330, and 2340 to the host die 2200 using the interposer 2150. The interposer 2150 may be on the PCB 2100 and may be electrically connected to the PCB 2100 through flip chip bumps FB.

The host die 2200, the logic die 3300, and the HBMs 2310, 2320, 2330, and 2340 having a stacked structure may be on the interposer 2150. TSV lines may be formed in the plurality of HBMs 2310, 2320, 2330, and 2340 to implement the memory system 2000. The TSV lines may be electrically connected to micro bumps MB formed between the plurality of HBMs 2310, 2320, 2330, and 2340.

Here, the compressed transformer model of the present disclosure may be loaded into at least one of the plurality of HBMs 2310, 2320, 2330, and 2340 or a working memory (e.g., SRAM) of the logic die 2300. In addition, in some embodiments and in response to a request from the host die 2200, natural language processing or an application operation by the compressed transformer model may be performed in the logic die 2300 instead of the host die 2200.

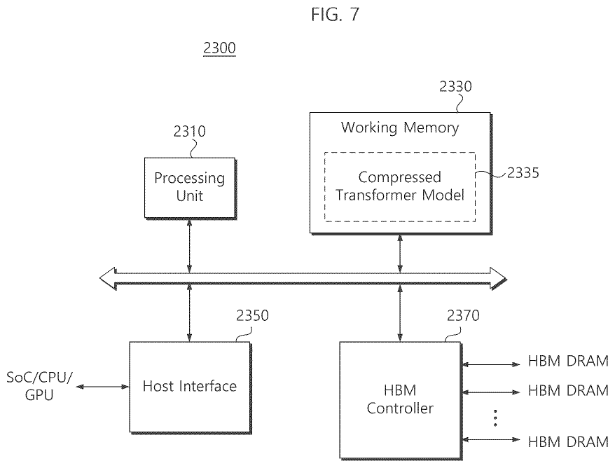

FIG. 7 is a block diagram illustrating a configuration of the logic die of FIG. 6. Referring to FIG. 7, the logic die 2300 may include a processing unit 2310, a working memory 2330, a host interface 2350, an HBM controller 2370, and a system bus 2390.

The processing unit 2310 may be configured to execute algorithms or software to be performed on the logic die 2300. The processing unit 2310 may execute the firmware or algorithms that are loaded into the working memory 2330. The processing unit 2310 may specifically implement the compressed transformer model 2335. The compressed transformer model 2335 may be a model that is compressed through the two-step quantization learning operation of the present disclosure described above to a sufficient degree to be loaded into the memory system 2000.

Algorithms or software that are to be executed in the logic die 2300, data being processed or processed, and/or processed data may be loaded into the operation memory 2330. In particular, the compressed transformer model 2335 may be loaded into the operation memory 2330. In some embodiments, the compressed transformer model 2335 may be loaded into at least one of the plurality of HBMs 2310, 2320, 2330, and 2340.

The host interface 2350 may be configured to provide an interface between the host die 2200 and the logic die 2300. The host die 2200 and the logic die 2300 may be connected through one of various standardized interfaces.

The HBM controller 2370 may be configured to provide an interface between the logic die 2300 and the plurality of HBMs 2310, 2320, 2330, and 2340. For example, data processed by the processing unit 2310 may be stored in at least one of the plurality of HBMs 2310, 2320, 2330, and 2340 through the HBM controller 2370. As another example, data stored in the plurality of HBMs 2310, 2320, 2330, and 2340 may be provided to the logic die 2300 through the HBM controller 2370.

According to the above description, the compressed transformer model 2335 of the present disclosure may be loaded into the general memory system 2000 instead of a large-scale system, and may provide a transformer operation. The compressed transformer model 2335 may provide relatively high quantization accuracy according to the two-step quantization learning operation of the present disclosure. Accordingly, the transformer calculation function may be implemented in a relatively lightweight system such as the memory system 2000 or a mobile device.

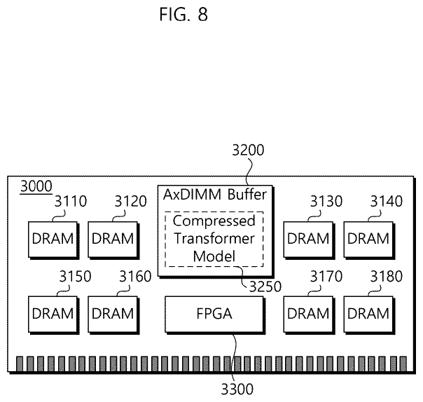

FIG. 8 is a diagram showing a memory system to which a compressed transformer model may be applied according to one or more embodiments of the present disclosure. Referring to FIG. 8, an acceleration double-sided memory module 3000 (Acceleration DIMM: hereinafter, AxDIMM) is shown as an example of a memory system equipped with an artificial intelligence engine. The AxDIMM 3000 may include a plurality of DRAM chips 3110 to 3180, an AxDIMM buffer 3200, and an FPGA 3300.

When the AxDIMM 3000 is booted or initialized, the compressed transformer model 3250 that is stored in a ROM or nonvolatile memory device may be loaded into the AxDIMM buffer 3200. In another embodiment, the compressed transformer model 3250 may be loaded into at least one of the plurality of DRAM chips 3110 to 3180.

The FPGA 3300 may drive various software or artificial intelligence engines loaded in the AxDIMM buffer 3200. The FPGA 3300 may, for example, drive the compressed transformer model 3250 and process the requested natural language processing task inside the AxDIMM 3000. Natural language processing, recognition, or various application operations may be performed inside the AxDIMM 3000 by the compressed transformer model 3250. The amount of data movement between the AxDIMM 3000 and the external host may be reduced, and in some cases may be significantly reduced, as a result of the compressed transformer model 3250 being inside the AxDIMM 3000. As such, the occurrence of data transmission between the AxDIMM 3000 and an external device (e.g., the external host) for artificial intelligence operations and/or transformer operation may be reduced or minimized to a degree such that the memory bandwidth reduction of the AxDIMM 3000 does not occur. In addition, since the operation may be performed inside the AxDIMM 3000, a decrease in processing speed caused by data transmission can also be prevented.

Additionally, the energy consumption of the memory system is greater during the movement of data than during the internal operation. Accordingly, when the AxDIMM 3000 of the present disclosure is used, data movement to the external device of the memory module for the transformer operation is comparatively small, so the operation speed is increased and power consumption is also reduced.

The above are some examples of embodiments for carrying out the present disclosure. In addition to the above-described embodiments, the present disclosure encompasses the above-described embodiments modified with simple design changes or easily changeable aspects or components. Further, the present disclosure includes not only the techniques described herein, but modifications to the techniques that can be easily performed and implemented using the above-described embodiments. Therefore, the scope of the present disclosure should not be limited to the above-described embodiments, and should be defined by the claims and equivalents of the claims of the present disclosure provided herein.

What is claimed is:

1. A method for quantization learning by a model quantizer operating in a computer system and compressing a transformer model, the method comprising:
generating a student model through quantization of the transformer model;
performing a first quantization learning by inserting a first self-attention map of a teacher model into a second self-attention map of the student model; and
performing a second quantization learning using a knowledge distillation method so that the second self-attention map of the student model follows the first self-attention map of the teacher model.

2. The method of claim 1, wherein the first self-attention map of the teacher model that is inserted into the second self-attention map of the student model corresponds to a third self-attention map of the transformer model prior to the quantization of the transformer model.

3. The method of claim 2, wherein the first quantization learning further comprises not providing a gradient value of at least one weight to a second parameter part so that parameter learning of a first parameter part related to the second self-attention map is suppressed.

4. The method of claim 3, wherein the at least one weight corresponds to a query weight and a key weight of input data.

5. The method of claim 1, wherein the second quantization learning further comprises calculating a loss value between the second self-attention map of the student model and the first self-attention map of the teacher model using a Kullback-Leibler divergence method.

6. The method of claim 5, wherein the loss value corresponds to a probability distribution distance between parameters of the second self-attention map of the student model and parameters of the first self-attention map of the teacher model.

7. The method of claim 5, wherein the second quantization learning further comprises providing gradient values of weights to a second parameter part unrelated to the second self-attention map of the student model so that parameter learning of a first parameter part related to the second self-attention map of the student model occurs.

8. A computer system for compressing a transformer model, comprising:
a processor; and
a memory storing non-transitory computer-readable instructions that include an executable model quantizer software configured to be executed by the processor to compress the transformer model,
wherein, when executed, the model quantizer software is configured to:
perform a first quantization learning by generating a student model through quantization of the transformer model, and inserting a first self-attention map of a teacher model into a second self-attention map of the student model to perform quantization learning; and
perform a second quantization learning by using a knowledge distillation method so that the second self-attention map of the student model follows the first self-attention map of the teacher model.

9. The computer system of claim 8, wherein the first self-attention map of the teacher model corresponds to a third self-attention map of the transformer model prior to the quantization of the transformer model.

10. The computer system of claim 9, wherein the processor is further configured to execute the model quantizer software to perform the first quantization learning by not providing a gradient value of at least one weight so that parameter learning of a first parameter unit related to the second self-attention map is suppressed.

11. The computer system of claim 10, wherein the at least one weight includes a query weight and a key weight of input data.

12. The computer system of claim 8, wherein the processor is further configured to execute the model quantizer software to perform the second quantization learning by calculating a loss value between the second self-attention map of the student model and the first self-attention map of the teacher model using a Kullback-Leibler Divergence method.

13. The computer system of claim 12, wherein the loss value corresponds to a probability distribution distance of each parameter of the second self-attention map of the student model and the first self-attention map of the teacher model.

14. The computer system of claim 13, wherein the processor is further configured to execute the model quantizer software to perform the second quantization learning by activating a gradient value of query weights, key weights, and value weights so that learning of parameters related to the second self-attention map of the student model occurs.

15. A quantization learning method for compressing a transformer model, the method comprising:
generating a student model and a teacher model through quantization of the transformer model;
performing a first quantization learning on the student model by replacing a second self-attention map of the student model with a first self-attention map of the teacher model; and
performing a second quantization learning on the student model so that the second self-attention map of the student model follows the first self-attention map of the teacher model.

16. The method of claim 15, wherein the teacher model corresponds to the transformer model prior to the quantization of the transformer model.

17. The method of claim 16, wherein the first quantization learning further comprises not providing a gradient transmission of at least one weight so that learning of parameters related to the second self-attention map is suppressed.

18. The method of claim 17, wherein the at least one weight includes a query weight and a key weight of input data.

19. The method of claim 15, wherein the second quantization learning further comprises calculating a loss value between the second self-attention map of the student model and the first self-attention map of the teacher model using a Kullback-Leibler divergence method.

20. The method of claim 19, wherein the loss value corresponds to a probability distribution distance between parameters of the second self-attention map of the student model and the first self-attention map of the teacher model.
